(19) United States
(12) Patent Application Publication
(10) Pub. No.: US 2005/0014859 A1
(43) Pub. Date: Jan. 20, 2005

(54) Adhesive film

(76) Inventors: Hironobu Iyama, Tsukuba-shi (JP); Toru Fujiki, Tsukuba-shi (JP)

Correspondence Address: BIRCH STEWART KOLASCH & BIRCH, PO BOX 747, FALLS CHURCH, VA, 22040-0747, US

(21) Appl. No.: 10/891,019

(22) Filed: Jul. 15, 2004

(30) Foreign Application Priority Data
Jul. 18, 2003 (JP) 2003-199024

(51) Int. Cl. C08G 2/00

(52) U.S. Cl. 522/1

(57) ABSTRACT

An object of the present invention is to provide an adhesive film excellent in processibility, thermosetting property, adherability and solder heat resistance. There is provided an adhesive film obtained by a method comprising a step of molding a thermosetting resin composition comprising component (A) and component (B) into a film, and a step of irradiating the film with an electron beam: (A): a polyvalent carboxylic acid containing two or more carboxyl groups, or anhydride thereof; (B): an ethylene copolymer containing epoxy group obtained by addition polymerization of at least one of monomer (b1) and monomer (b2):

### FILED OF THE INVENTION

The present invention relates to an adhesive film obtained by irradiating a film of a thermosetting resin composition with an electron beam; a device for a semiconductor apparatus obtained by laminating the adhesive film on an adherend, and thermally curing the laminate; a semiconductor apparatus containing the device.

### BACKGROUND OF THE INVENTION

Recently, in the field of electric and electronic parts, weight-saving, thinning and down-sizing for the parts are being progressed, and an adhesive which is used for semiconductor sealing materials, sealing materials for electronic parts such as a solar battery and an EL (electro luminescence) lamp, die bonding sheet for integrated circuit/substrate, and electric and electronic parts such as an interlayer insulating layer between substrates is required to have a low elastic modulus and a reduced thickness in addition to heat resistance to a solder (hereinafter, referred to as solder heat resistance). And, for simplifying a step of manufacturing electric and electronic parts, a form of an adhesive before curing is required to be in the form of dry film.

Such the film was suggested by, for example, JP 60-240747A disclosing across-linked olefin copolymer composition composed of an α-olefin copolymer containing a dicarboxylic anhydride group and an α-olefin copolymer containing an epoxy group.

The present inventors studied a cross linking resin composition obtained by melting and kneading a composition composed of an α-olefin copolymer containing a dicarboxylic anhydride group and an α-olefin copolymer containing an epoxy group, and found that an α-olefin copolymer containing a dicarboxylic anhydride group produces, as a byproduct, a component containing carboxyl group due to degradation of dicarboxylic anhydride group during the aforementioned melting and kneading step, and that the byproduct and an epoxy group contained in the aforementioned α-olefin copolymer are subjected to cross-linking reaction, resulting in deteriorating processibility upon molding into a film.

### SUMMARY OF THE INVENTION

An object of the present invention is to provide an adhesive film excellent in processibility, thermosetting property, adherability and solder heat resistance.

The present inventors intensively studied and found, as a result, that the above object can be attained by an adhesive film obtained by irradiating a molded thermosetting resin composition containing polyvalent carboxylic acid or anhydride thereof and an ethylene copolymer containing specific epoxy group with an electron beam, or attained by an adhesive film obtained by coating on a supporting substrate a thermosetting resin composition containing polyvalent carboxylic acid or anhydride thereof, an ethylene copolymer containing specific epoxy group, and an organic solvent and/or water, removing the organic solvent and/or water, and then, irradiating the resulting composition on the supporting substrate with an electron beam. Therefore the present inventors completed the present invention.

That is, the present invention provides the following (i) or (ii):

(i) An adhesive film obtained by a method comprising a step of molding a thermosetting resin composition comprising component (A) and component (B) into a film, and a step of irradiating the film with an electron beam:
(A): a polyvalent carboxylic acid containing two or more carboxyl groups, or anhydride thereof;
(B): an ethylene copolymer containing epoxy group obtained by addition polymerization of at least one of monomer (b1) and monomer (b2):
   monomer(b1): at least one of ethylene and propylene;
   monomer(b2): a monomer represented by the following formula (1): 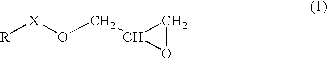
      (wherein R represents a hydrocarbon group of from 2 to 18 carbon number having one or more double bond(s), wherein a hydrogen atom of the hydrocarbon group may be substituted with a halogen atom, a hydroxyl group or a carboxyl group, and X represents a single bond or a carbonyl group);

(ii) An adhesive film obtained by a method comprising a step of coating on a supporting substrate a thermosetting resin composition which comprises the component (A), the component (B) and the following component (D) and, further, optionally comprises a component (C), a step of removing the component (D), and a step of irradiating the resulting composition on a supporting substrate with an electron beam;
component (C): antioxidant;
component (D): organic solvent and/or water.

Also, the preset invention also provides a laminate obtained by a method comprising a step of laminating the adhesive film and an adherend, and a step of thermally curing the laminate, a device for a semiconductor apparatus; a semiconductor apparatus containing the device.

The present invention will be explained in detail below.

### DETAILED DESCRIPTION OF THE PREFERRED EMBODIMENTS

In the adhesive films (i) and (ii) of the present invention, the component (A) constituting a thermosetting resin composition is at least one monomer compound selected from polyvalent carboxylic acid having two more carboxyl groups, and anhydrides thereof.

Examples of the polyvalent carboxylic acid include the following aliphatic polyvalent carboxylic acids and aromatic polyvalent carboxylic acids:

<Aliphatic Polyvalent Carboxylic Acid>

Succinic acid, adipic acid, azelaic acid, sebacic acid, dodecanedicarboxylic acid, itaconic acid, maleic acid, citraconic acid, tetrahydrophthalic acid, hexahydrophthalic acid, methyl tetrahydrophthalic acid, cyclopentanetetracarboxylic acid, 1,2,3,4-butanetetracarboxylic acid, oxalic acid, citric acid, tartaric acid and the like;

<Aromatic Polyvalent Carboxylic Acid>

Phthalic acid, terephthalic acid, isophthalic acid, trimellitic acid, pyromellitic acid, benzophenonetetracarboxylic acid and the like

Examples of the polyvalent carboxylic anhydride include the following aliphatic dicarboxylic anhydrides, aliphatic polyvalent carboxylic dianhydrides, aromatic polyvalent carboxylic anhydrides and acid anhydrides containing ester group:

<Aliphatic Dicarboxylic Anhydride>

Itaconic anhydride, maleic anhydride, succinic anhydride, citraconic anhydride, dodecenylsuccinic anhydride, tetrahydrophthalic anhydride, hexahydrophthalic anhydride, methyltetrahydrophthalic anhydride, methylhexahydrophthalic anhydride, endomethylenetetrahydrophthalic anhydride or methylendomethylenetetrahydrophthalic anhydride, chlorendic anhydride and the like;

<Aliphatic Polyvalent Dianhydride>

Cyclopentanetetracarboxylic dianhydride, 1,2,3,4-butanetetracarboxlic dianhydride, maleinated methylcyclohexene tetrabasic anhydride and the like;

<Aromatic Polyvalent Carboxylic Anhydride>

Phthalic anhydride, trimellitic anhydride, pyromellitic anhydride, benzophenonetetracarboxylic anhydride, 3,3′,4,4′-diphenylsulfonetetracarboxylic dianhydride and the like;

<Acid Anhydride Containing Ester Group>

Ethylene glycol bistrimellitate, glycerin tristrimellitated anr the like.

As the component (A) constituting a thermosetting resin composition in the adhesive films (i) and (ii) of the present invention, among the above-exemplified compounds, aliphatic polyvalent carboxylic acids, aromatic polyvalent carboxylic acids having an alkyl group of 2 or more carbon number, and anhydrides thereof are preferable, from the view point of better affinity with the component (B).

The component (B) constituting a thermosetting resin composition in the adhesive films (i) and (ii) of the present invention is an ethylene copolymer containing epoxy group obtained by addition polymerization of at least one of ethylene and propylene as a monomer (b1) and a monomer represented by the formula (1) as a monomer (b2).

As the monomer (b1), ethylene is preferable.

Examples of R in the formula (1) include groups of the following formulas (2) to (8):

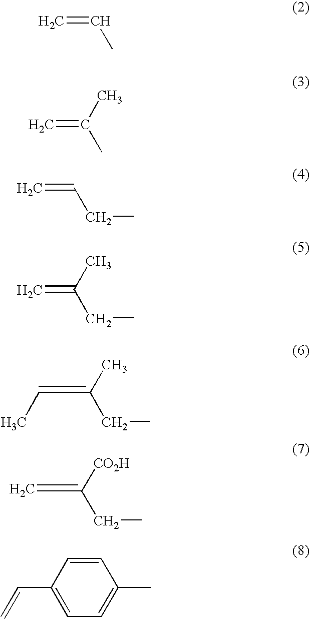

X in the formula (1) represents a single bond or a carbonyl group.

Examples of the monomer (b2) include unsaturated glycidyl ether such as allylglycidyl ether, 2-methylallylglycidyl ether, styrene-p-glycidyl ether and the like, and unsaturated glycidyl ester such as glycidyl acrylate, glycidylmethacrylate, itaconic acid glycidyl ester and the like.

A content of a repeating unit derived from the monomer (b2) is preferably from about 1 to 30 parts by weight relative to 100 parts by weight of the component (B). When the repeating unit derived from the monomer (b2) is 1 part by weight or more, adhesion property of the resulting adhesive film tends to be improved, being preferable. When the repeating unit derived form the monomer (b2) is 30 parts by weight or less, a mechanical strength of an adhesive film tends to increase, being preferable.

In addition, it is preferable that a content of a repeating unit derived from the monomer (b1) is from about 30 to 99 parts by weight relative to 100 parts by weight of the component (B).

Further, in addition to (b1) and (b2), a monomer (b3) having a functional group copolymerizable with ethylene which is a different monomer from (b1) and (b2) maybe addition-polymerized with (b1) and (b2).

The monomer (b3) may be contain an ester group and does not contain a functional group such as a carboxyl group (—COOH) or an acid anhydride group (—CO—O—CO—) which may be capable of reacting with an epoxy group.

Examples of the monomer (b3) include α,β-unsaturated carboxylic acid alkyl esters having an alkyl group of from about 3 to 8 carbon number such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate; vinyl esters having carboxylic acid of from about 2 to 8 carbon number such as vinyl acetate, vinyl butyrate, vinyl propionate, vinyl pivalate, vinyl laurate, vinyl isononanate and vinyl versatate; α-olefins of from 3 to 20 carbon number such as propylene, 1-butene and isobutene; diene compounds such as butadiene, isoprene and cyclopentadiene; vinyl compounds such as vinyl chloride, styrene, acrylonitrile, methacrylonitrile, acrylamide and methacrylamide.

The preferable (b3) includes propylene, vinyl acetate, methyl acrylate, ethyl acrylate, n-butyl acrylate and methyl methacrylate.

A content of a repeating unit derived from (b3) in the component (B) is usually from about 0 to 70 parts by weight, preferably from about 5 to 60 parts by weight relative to 100 parts by weight of an ethylene copolymer containing epoxy group of the component (B). When the content of a repeatingl unit derived from the (b3) in the component (B) is 70 parts by weight or less, there is a tendency that the component (B) can be easily prepared by a high-pressure radical method, being preferable.

The component (B) in the present invention may be any one of a block copolymer, a graft copolymer, a random copolymer and an alternating copolymer, and examples include a copolymer in which a propylene-ethylene block copolymer is grafted with a (b2) described in Japanese Patent No. 2632980 (this reference is incorporated herein), and a copolymer in which a copolymer of an ethylene and monomer containing epoxy group is grafted with an α,β-unsaturated carboxylic acid ester described in Japanese Patent No.2600248 (this reference is incorporated herein).

Examples of a process for preparing the component (B) in the present invention include a method of copolymerizing monomers at the temperature in the range of about 100 to 300° C. and inder the pressure in the range of about 500 to 4000 atm in the presence of ethylene and a radical generator and in the presence or the absence of a suitable solvent and a chain transfer agent; a method of mixing a polyethylene resin with the (b2) together with a radical generator, and melting graft-copolymerizing the mixture in an extruder.

The polyethylene resin is a homopolymer of (b1), or a copolymer of a (b1) and a (b3).

In the component (B) in the present invention, MFR [melt flow rate (measured at 190° C. and a load of 2.16 kg)] measured according to JIS K7210 is usually around 1 to 1000 g/10 min, preferably around 1 to 500 g/10 min.

When MFR is 1 or more, flowability of the resulting thermosetting resin component is improved and, even when the surface of an adherend is not smooth, the surface can be smoothly covered.

On the other hand, when MFR is 500 or smaller, there is a tendency that solder heat resistance of the resulting thermosetting resin composition is improved.

As the component (B), commercially available products such as “Bond Fast (registered trademark)” series (manufactured by Sumitomo Chemical Co., Ltd.), “SEPOLSION G (registered trademark)” series (manufactured by Sumitomo Seika Chemical Co., Ltd), and “Lexpearl RA (registered trade mark)” series (manufactured by Nippon Polyolefin) may be used.

A thermosetting resin composition in the adhesive film (i) of the present invention contains the component (A) and the component (B). In the thermosetting resin composition, the component (A) and the component (B) are usually compatible.

In the thermosetting resin composition in the adhesive film (i) of the present invention, a weight ratio of the component (A) and the component (B) is usually about (A)/(B)=0.01/99.95 to 5/95.

A thermosetting resin composition in the adhesive film (i) of the present invention may contain a promoter for curing an epoxy resin such as an amine compound, imidazoles and an organic phosphorus compound in order to promote a curing reaction of the component (A) and the component (B).

When a thermosetting resin composition in the adhesive film (i) of the present invention contains an antioxidant (C) in addition to the component (A) and the component (B), there is a tendency that upon molding into a film, occurrence of an non-uniform extraneous materials called “fish eye” is suppressed, and that storage stability of a thermosetting resin composition and an adhesive film obtaining from the composition is improved, being preferable.

Examples of the antioxidant as the component (C) in the adhesive film (i) of the present invention include a phenolic antioxidant, a phosphoric antioxidant, a sulfuric antioxidant, and an amine antioxidant. Two or more of antioxidants may be used in combination thereof. In particular, from a viewpoint of a effect for preventing gellation and coloring, it is preferable to use a phenolic antioxidant, a phosphoric antioxidant and a sulfuric antioxidant in combination.

Examples of the phenolic antioxidant include
2,6-di-t-butyl-4-methylphenol, 2,6-di-t-butyl-4-ethylphenol,
2,6-dicyclohexyl-4-methylphenol,
2,6-di-t-amyl-4-methylphenol,
2,6-di-t-octyl-4-n-propylphenol,
2,6-dicyclohexyl-4-n-octylphenol,
2-isopropyl-4-methyl-6-t-butylphenol,
2-t-butyl-2-ethyl-6-t-octylphenol,
2-isobutyl-4-ethyl-6-t-hexylphenol,
2-cyclohexyl-4-n-butyl-6-isopropylphenol, dl-α-tocopherol,
t-butylhydroquinone,
2,2′-methylenebis(4-methyl-6-t-butylphenol),
4,4′-butylidenebis(3-methyl-6-t-butylphenol),
4,4′-thiobis(3-methyl-6-t-butylphenol),
2,2′-thiobis(4-methyl-6-t-butylphenol),
4,4′-methylenebis(2,6-di-t-butylphenol),
2,2′-methylenebis[6-(1-methylcyclohexyl)-p-cresol],
2,2′-ethylidenebis(4,6-di-t-butylphenol),
2,2′-butylidenebis( 2-t-butyl-4-methylphenol),
2-t-butyl-6-(3-t-butyl-2-hydroxy-5-methylbenzyl)-4-methylphenyl acrylate,
2-[1-(2-hydroxy-3,5-di-t-pentylphenyl)ethyl]-4,6-di-t-pentylphenyl acrylate,
1,1,3-tris(2-methyl-4-hydroxy-5-t-butylphenyl)butane, triethylene glycol bis-[3-(3-t-butyl-5-methyl-4-hydroxyphenyl)propionate],
1,6-hexanediol bis-[3-(3,5-di-t-butyl-4-hydroxyphenyl)propionate],
2,2-thiodiethylene bis-[3-(3,5-di-t-butyl-4-hydroxyphenyl)propionate],
N,N′-hexamethylene bis-(3,5-di-t-butyl-4-hydroxy-hydrocinnamide),
3,5-di-t-butyl-4-hydroxybenzylphosphonate diethyl ester, tris(2,6-dimethyl-3-hydroxy-4-t-butylbenzyl)isocyanurate,
tris(3,5-di-t-butyl-4-hydroxybenzyl)isocyanurate,
tris[(3,5-di-t-butyl-4-hydroxyphenyl)propionyloxyethyl]isocyanurate,
tris(4-t-butyl-2,6-dimethyl-3-hydroxybenzyl)isocyanurate,
2,4-bis(n-octylthio)-6-(4-hydroxy-3,5-di-t-butylanilino)-1,3,5-triazine,
tetrakis[methylene-3-(3,5-di-t-butyl-4-hydroxyphenyl)propionate]methane,
2,2′-methylenebis(4-methyl-6-t-butylphenol)terephthalate,
1,3,5-trimethyl-2,4,6-tris(3,5-di-t-butyl-4-hydroxybenzyl)benzene,
3,9-bis[1,1-dimethyl-2-{β-(3-t-butyl-4-hydroxy-5-methyl-phenyl)pripionyloxy}ethyl]-2,4,8,10-tetraoxaspiro[5,5]undecane,
2,2-bis[4-(2-(3,5-di-t-butyl-4-hydroxyhydrocinnamoyloxy))ethoxyphenyl]propane, and
β-(3,5-di-t-butyl-4-hydroxyphenyl)propionic acid stearyl ester.

Among these,
β-(3,5-di-t-butyl-4-hydroxyphenyl)propionic acid stearyl ester,
tetrakis[methylene-3-(3,5-di-t-butyl-4-hydroxyphenyl)propionate]methane,
tris(3,5-di-t-butyl-4-hydroxybenzyl)isocyanurate,
1,3,5-trimethyl-2,4,6-tris(3,5-di-t-butyl-4-hydroxybenzyl)benzene, dl-α-tocopherol,
tris(2,6-dimethyl-3-hydroxy-4-t-butylbenzyl)isocyanurate,
tris[(3,5-di-t-butyl-4-hydroxyphenyl)propionyloxyethyl]isocyanurate,
3,9-bis[1,1-dimethyl-2-{β-(3-t-butyl-4-hydroxy-5-methyl-phenyl)propionyloxy}ethyl]-2,4,8,10-tetraoxaspiro[5,5]undec ane are preferable.

As the phenolic antioxidant, commercially available products may be used. Examples of a commercial available phenolic antioxidant include Irganox 1010 (manufactured by Ciba Specialty Chemicals), Irganox 1076 (manufactured by Ciba Specialty Chemicals), Irganox 1330 (manufactured by Ciba Specialty Chemicals), Irganox 3114 (manufactured by Ciba Specialty Chemicals), Irganox 3125 (manufactured by Ciba Specialty Chemicals), Sumilizer BHT (Sumitomo Chemical Co., Ltd.), Cyanox 1790 (manufactured by Cytech Products, Inc.), Sumilizer GA-80 (manufactured by Sumitomo Chemical Co., Ltd.) and vitamin E (manufactured by Esai).

As the phenolic antioxidant, two or more of phenolic antioxidants may be used.

In the thermosetting resin composition in the present invention, an amount of the phenolic antioxidant to be incorporated is usually about 0.005 to 2 parts by weight, preferably about 0.01 to 1 part by weight, more preferably about 0.05 to 0.5 parts by weight relative to 100 parts by weight of component (A).

Examples of the phosphoric antioxidant include trioctyl phosphate, trilauryl phosphite, tridecyl phosphate, (octyl)diphenyl phosphite, tris(2,4-di-t-butylphenyl)phosphite, triphenyl phosphate, tris(butoxyethyl)phosphate, tris(nonylphenyl)phosphate, distearylpentaerythritol diphosphite, tetra(tridecyl)-1,1,3-tris(2-methyl-5-t-butyl-4-hydroxy-phenyl)butane diphosphite, tetra(C₁₂-C₁₅ mixed alkyl)-4,4′-isopropylidenediphenyl diphosphite, tetra(tridecyl)-4,4′-butylidenebis(3-methyl-6-t-butylphenol)diphosphite, tris(3,5-di-t-butyl-4-hydroxyphenyl)phosphite, tris(mono- and di- mixed nonylphenyl)phosphite, hydrogenated-4,4′-isopropylidenediphenol polyphosphite, bis(octylphenyl)bis[4,4′-butylidenebis(3-methyl-6-t-butyl-phenol)]-1,6-hexanediol diphosphite, phenyl(4,4′-isopropylidenediphenol)pentaerythritol diphosphite, distearylpentaerythritol diphosphite, tris[4,4′-isopropylidenebis(2-t-butylphenol)]phosphite, di(isodecyl)phenyl phosphate, 4,4′-isopropylidenebis(2-t-butylphenol)bis(nonylphenyl)phosphite, 9,10-dihydro-9-oxa-10-phosphaphenanthrene-10-oxide, bis(2,4-di-t-butyl-6-methylphenyl)ethyl phosphite, 2-[{2,4,8,10-tetra-t-butyldibenz[d,f][1.3.2]-dioxa-phosphepin-6-yl}oxy]-N,N-bis[2-[{2,4,8,10-tetra-t-butyl-dibenz[d,f][1.3.2]-dioxaphosphepin-6-yl}oxy]ethyl]-ethaneamine, and 6-[3-(3-t-butyl-4-hydroxy-5-methylphenyl)propoxy]-2,4,8,10-tetra-t-butyldibenz[d,f][1.3.2]-dioxaphosphepine.

Examples of the bis(dialkylphenyl)pentaerythritol diphosphite ester include a spiro type represented by the following formula (9): 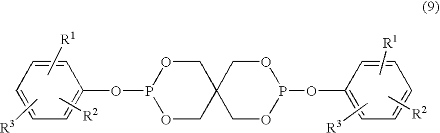
(wherein R¹, R² and R³ represent independently a hydrogen atom or an alkyl group of from 1 to 9 carbon number), and a cage type represented by the following formula (10): 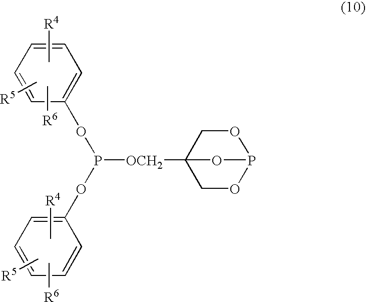
(wherein R⁴, R⁵ and R⁶ represent independently a hydrogen atom or an alkyl group from 1 to 9 carbon number).

As such the phosphite ester, usually, a mixture of the formula (9) and the formula (10) is used.

When R¹ to R⁶ are alkyl group, branched alkyl group is preferable, and t-butyl group is more preferable. As a substituting position of R¹ to R⁶ in a phenyl group, 2, 4 and 6 positions are preferable.

Examples of the phosphate ester include bis(2,4-di-t-butylphenyl)pentaerythritol diphosphite, bis(2,6-di-t-butyl-4-methylphenyl)pentaerythritol diphosphite and bis(nonylphenyl)pentaerythritol diphosphite. As phosphonite having a structure in which carbon and phosphorus are directly bound, there is a compound such as tetrakis(2,4-di-t-butylphenyl)-4,4′-biphenylene diphosphonite.

As the phosphoric antioxidant, commercially available products may be used. Examples of such the commercially available phosphoric antioxidant include Irgafos 168 (manufactured by Ciba Specialty chemicals), Irgafos 12 (manufactured by Ciba Specialty chemicals), Irgafos 38 (manufactured by Ciba Specialty chemicals), ADK STAB 329K (manufactured by Asahi Denka Kogyo K.K.), ADK STAB PEP36 (manufactured by Asahi Denka Kogyo K.K.), ADK STAB PEP-8 (manufactured by Asahi Denka Kogyo K.K.), Sandstab P-EPQ (manufactured by Clariant), Weston 618 (manufactured by GE), Weston 619G (manufactured by GE), Ultranox 626 (manufactured by GE), and Sumilizer GP (manufactured by Sumitomo Chemical Co., Ltd.).

As the phosphoric antioxidant, two or more kinds of phosphoric antioxidants may be used. In the thermosetting resin composition in the present invention, an amount of the phosphoric antioxidant to be incorporated is usually 0.005 to 2 parts by weight, preferably 0.01 to 1 part by weight, more preferably 0.05 to 0.5 part by weight relative to 100 parts by weight of the component (A).

Among the phosphoric antioxidants, tris(2,4-di-t-butylphenyl)phosphate, tetrakis(2,4-di-t-butylphenyl)-4,4′-diphenylene diphosphonite, distearylpentaerythritol diphosphite, bis(2,4-di-t-butylphenyl)pentaerythritol diphosphite, 2-[{2,4,8,10-tetra-t-butyldibenz[d,f][1.3.2]-dioxa-phosphepin-6-yl}oxy]-N,N-bis[2-[{2,4,8,10-tetra-t-butyl-dibenz[d,f][1.3.2]-dioxaphosphepin-6-yl}oxy]ethyl]-ethaneamine and 6-[3-(3-t-butyl-4-hydroxy-5-methylphenyl)propoxy]-2,4,8,10-tetra-t-butyldibenz[d,f][1.3.2]-dioxaphosphepine are preferable.

Examples of the sulfuric antioxidant include dialkylthiodipropionate such as dilaurylthiodipropionate, dimyristylthiodipropionate, and distearylthiodipropionate; polyhydric alcohol (e.g. glycerin, trimethylolethane, trimethylolpropan, pentaerythritol, and trishydroxyethyl isocyanurate) ester of alkylthiopropionic acid (e.g. pentaerythryltetrakis-3-laurylthiopropionate) such as butylthiopropionic acid, octylthiopropionic acid, laurylthiopropionic acid, and stearylthiopropionic acid.

More specifically, examples include dilaurylthiodipropionate, dimyristylthiodipropionate, distearylthiodipropionate, laurylstearylthiodipropionate, distearylthiodibutyrate, and the like.

Among these, pentaerythryltetrakis-3-laurylthiopropionate is preferable.

Examples of the sulfuric antioxidant include Sumilizer TPS (manufactured by Sumitomo Chemical Co., Ltd.), Sumilizer TPL-R (manufactured by Sumitomo Chemical Co., Ltd), Sumilizer TPM (manufactured by Sumitomo Chemical Co., Ltd), and Sumilizer TP-D (manufactured by Sumitomo Chemical Co., Ltd).

As the sulfuric antioxidant, two or more of sulfuric antioxidants may be used.

In the composition in the present invention, an amount of the sulfuric antioxidant to be incorporated is usually 0.005 to 2 parts by weight, preferably 0.01 to 1 part by weight, more preferably 0.05 to 0.5 part by weight relative to 100 parts by weight of the component (A).

Examples of the amine antioxidant include 2,2,4-trimethyl-1,2,dihydroquinoline polymer, 6-ethoxy-2,2,4-trimethyl-1,2-dihydroquinoline, N-(1,3-dimethylbutyl)-N′-phenyl-1,4-phenylenediamine and N-isopropyl-N′-phenyl-1,4-phenylenediamine.

The adhesive film (i) of the present invention is obtained by molding the aforementioned thermosetting resin composition comprising the component (A) and the component (B) into a film, and irradiating the resulting film with an electron beam.

Examples of a process for preparing the adhesive film (i) include (i-a) a method of extruding the thermosetting resin composition used for the present invention into a film with a T die extruder, (i-b) a method of extruding the thermosetting resin composition used for the present invention into a film on a supporting substrate with a T die extruder, and (i-c) a method of laminating the film obtained in the (i-a) on a supporting substrate.

Examples of a process for preparing the thermosetting resin composition include a method of melting and kneading the component (A) usually at the temperature in the range of about 120 to 200° C. using a monoaxial or biaxial screw extruder, a Banbuty mixer, a roll, various kneaders and the like, and then, mixing the component (B) therein; a method of dry-blending the component (A) and the component (B), and melting and kneading the blend usually at the temperature in the range of about 90 to 180° C. using a monoaxial or biaxial screw extruder, a Banbury mixer, a roll, various kneaders and others.

When the component (B) is in the form of agglomerate, the component (B) is ground into a powder with a grinder such as a feather mill, a Nara-type grinder and an air mill, and thereafter, the powder is mixed. Since melting and kneading are simplified, this method is preferable.

It is preferable that a component (C) together with the component (A) is melted and kneaded.

Further, the thermosetting resin composition used for the present invention may contain an additive such as a coloring agent, an inorganic filler, a process stabilizer, a weather resistance agent, a thermal stabilizer, a light stabilizer, a nucleating agent, a lubricant, a releasing agent, a flame retardant and an antistatic agent.

When the thermosetting resin composition is used for a solder resist, a coloring agent such as a dye and a pigment such as phthalocyanine blue and carbon black is usually used in order to mask a conductor circuit on the surface of a printed circuit board.

The adhesive film (ii) of the present invention is obtained by coating a thermosetting resin composition comprising the (A), (B) and component (D) and further optionally comprising a component (C) is coated on a supporting substrate, removing the component (D), and irradiating the resulting composition on the supporting substrate with an electron beam.

Example of a process for preparing the adhesive film (ii) include (ii-a) a method comprising a step of coating an adhesive obtained by dissolving or dispersing the thermosetting resin composition mentioned above in an organic solvent and/or water on an adherend, and a step of preparing an adhesive film on an adherend, and (ii-b) a method comprising a step of coating an adhesive obtained by dissolving or dispersing the thermosetting resin composition mentioned above in an organic solvent and/or water on a supporting substrate, a step of removing the component (D) by drying, and preparing an adhesive film on a supporting substrate.

For electric and electronic parts, in particular, the adhesive film obtained by the process (i-c) or (ii-a) is preferable.

A process for preparing a film obtained by extruding as in the (i-a) or (i-b) will be explained in detail. A distance between a T-die and a chill roll (air gap) is usually about 10 cm or less, preferably about 8 cm or less, more preferably about 6 cm or less.

When an air gap is 10 cm or less, there is a tendency that film breakage, and fluctuation in a film thickness generally called “uneven thickness” are suppressed, being preferable.

A melting and kneading temperature for obtaining an adhesive film is preferably a melting temperature of a resin used or higher and not more than a degradation temperature of the resin, usually 180° C. or lower. A melting and kneading temperature of 90 to 180° C. is more preferable.

A thickness of an adhesive film obtained by extruding is usually about 5 μm to 2 mm, preferably 8 μm to 1 mm.

Examples of a supporting substrate used in the present invention include a polyolefin film such as a film composed of 4-methyl-1-pentene copolymer; cellulose acetate film; a releasing type paper and a releasing type polyethylene terephthalate (PTE) film in a silicone releasing agent or a fluorine releasing agent is coated on a side adjacent to a layer composed of the thermosetting resin composition.

Then, the thermosetting resin composition described in a process for preparing the adhesive films (ii), (ii-a) and (ii-b) will be explained.

The thermosetting resin composition contains the component (D). Examples of an organic solvent in the component (D) include aromatic hydrocarbons such as toluene and xylene; esters such as ethyl acetate and butyl acetate; ketones such as acetone, methyl ethyl ketone and methyl isobutyl ketone; alcohols such as methanol, butanol, polyethylene glycol, partially saponified polyvinyl alcohol and completely saponified polyvinyl alcohol; chlorinated hydrocarbons such as methylene chloride; aliphatic hydrocarbons such as hexane, heptane and petroleum ether.

As an organic solvent in the component (D), two or more kinds of component (D) may be used.

When the component (D) is an organic solvent, aromatic hydrocarbons and ketones are preferably used.

When water is used as the component (D), it is preferable to use an emulsifying and dispersing agent such as partially saponified polyvinyl alcohol, completely saponified polyvinyl alcohol and polyethylene glycol jointly in order to disperse the (A) and (B) in water to improve storage stability of the thermosetting resin composition.

Examples of a process for preparing the thermosetting resin composition include a method of dissolving or dispersing the (A) and (B) in the component (D), respectively, and then mixing them, a method of dissolving or dispersing the (A) and (B) in the component (D) at the same time, and a process for emulsion-polymerizing an aqueous emulsion of the component (A) and/or the component (B), and preparing a mixture of emulsifying aqueous solutions of the (A) and (B).

The thermosetting resin composition of the adhesive film (i) of the present invention may contain an additive such as an inorganic filler, a pigment, a procession stabilizer, a weather resistance agent, a thermal stabilizer, a light stabilizer, a nucleating agent, a lubricant, a releasing agent, a flame-retardant and an antistatic agent in addition to the aforementioned antioxidant (C). When the thermosetting resin composition contains an inorganic filler, it is preferable that a content of the inorganic filler is 70 parts of weight or less relative to a total 100 parts by weight of the component (A) and the component (B).

As the thermosetting resin composition of the adhesive film (ii) of the present invention, a preferable molecular weight of (B) of the composition is such molecular weight that (B) can be uniformly dissolved, and that the composition has a viscosity appropriate to coating. In addition, from a viewpoint of adhesibility, a thickness of an adhesive film obtained by coating the thermosetting resin composition is about 3 μm or more, preferably about 3 to 100 μm, particularly preferable about 3 to 50 μm.

In the adhesive film (ii) of the present invention, a total weight of the component (A) and the component (B) in the thermosetting resin composition is preferably 10 to 150 parts by weight relative to 100 parts by weight of the component (D).

In the adhesive film (ii) of the present invention, when a total weight of the component (A) and the component (B) in the thermosetting resin composition is 10 parts by weight or more relative to 100 parts by weight of the component (D), coating property on a supporting substrate of the thermosetting resin composition is excellent and, when a total weight of component (A) and the component (B) is 150 part by weight or more relative to 100 parts by weight of the component (D), a viscosity of the thermosetting resin composition is reduced, and coating property on a supporting substrate is excellent.

Examples of a method of coating a thermosetting resin composition upon preparation of an adhesive film (ii) include a method using a roll coater such as a reverse roll coater, a gravure coater, a microbar coater, a kiss coater, a Meyer bar coater and an air knife coater, or a blade coater and the like.

From a viewpoint that a thickness of a film can be easily controlled from a thin film to a thick film, a method of coating using a roll coater is preferable.

In addition, examples of a drying method after coating include a method of air drying and a method using a heating and ventilating oven.

In the present invention, an adherend and the aforementioned adhesive film (i) or (ii) are laminated, and then, are adhered by heating and pressing and, thereupon, an electron beam is irradiated. By irradiation with an electron beam, a resin component of the adhesive film can be prevented from flowing out of the adherend.

An electron beam used in the present invention is a flux of electrons accelerated by a voltage. Any of a low energy type which is accelerated by a voltage of about 50 to 300 kV, an intermediate energy type which is accelerated at a voltage of about 300 to 5000 kV, and a high energy type which is accelerated by a voltage of about 5000 to 10000 kV can be used, but a low energy type electron type is preferably used.

Examples of an electron accelerator include a linear cathode type, a module cathode type, a thin plate cathode type and a low energy scanning type.

Examples of a method of irradiating an electron beam include a method of irradiating one surface, which is not covered with a supporting substrate, of a film obtained by extruding with an electron beam in the inert gas atmosphere such as nitrogen; a method of irradiating a surface covered with a supporting substrate with an electron beam; a method of irradiating one surface or both surfaces with an electron beam, after peeling a supporting substrate; a method of peeling a supporting substrate, laminating on an adherend described later in advance, and thereafter, irradiating the laminate with an electron beam.

A total irradiation dose of an electron beam is usually about 1 to 300 kGy, more preferably about 50 to 250 kGy. When an irradiation dose is 10 kGy or more, there is a tendency that, upon rolling of a film at heating adhesion or thermal curing, effect of sealing the surface of an adherend is improved, being preferable. When the dose is 300 kGy or less, there is a tendency that, even when the surface of an adherend is not smooth, the surface can be smoothly covered, and adhesibility is improved, being preferable.

The cured laminate of the present invention is a laminate obtained by laminating the adhesive film and the adherend, and thermally curing.

As the adherend, two or more kinds of adherends may be used.

The laminate of the present invention is prepared by the following method, by explaining referring to an adhesive film laminated with a supporting substrate.

(Method 1):

A method of peeling a supporting substrate from an adhesive film, laminating an adherend on both surfaces or one surface of the adhesive film, and then, thermally curing the laminate.

(Method 2):

A method of laminating an adherend on a surface of an adhesive film on which a supporting substrate is not laminated, then, peeling the supporting substrate from the adhesive film, and thereafter, if necessary, laminating an adherend different from the adherend on a surface from which the supporting substrate has been peeled, and then, thermally curing the laminate.

(Method 3):

A method of laminating a surface of an adhesive film on which a supporting substrate is not laminated and an adherend, and after thermal curing, peeling the supporting substrate from the laminate.

Thermal curing conditions for preparation of a laminate are such that a curing temperature is usually about 100° C. to 350° C., preferably about 120 to 300° C., more preferably about 140 to 200° C., and a heating time is about 10 minutes to 3 hours. When a thermal curing temperature is 100° C. or higher, there is a tendency that a thermal curing time until obtaining of solder heat resistance is shortened, being preferable. On the other hand, when a thermal curing temperature is 350° C. or lower, thermal deterioration of an adhesive is small, being preferable.

Alternatively, thermal curing may be performed in a range of atmospheric pressure to 6 MPa using a heatable press.

Examples of an adherend used in a laminate include materials which can adhere with the adhesive film of the present invention such as metals such as gold, silver, copper, ion, tin, lead, aluminum and silicon; inorganic materials such as glass and ceramic; cellulose polymer materials such as paper and fabric; synthetic polymer materials such as melamine resins, acrylic-urethane resins, urethane resins, (meth)acrylic resins, styrene-acrylonitrile copolymers, polycarbonate resins, phenol resins, alkyd resins, epoxy resins and silicone resins.

As the adherend material, different two or more materials may be mixed, or may be prepared into a composite.

In the case of a laminate in which different two adherends are adhered via the adhesive film of the present invention, materials constituting two adherends may be the same kind materials, or different kind materials.

A shape of the adherend is not particularly limited, but may be any of a film-like, a sheet-like, a plate-like and a fiber-like.

And, if necessary, the adherend may be subjected to surface treatment such as surface modification, surface oxidation, and etching, with a releasing agent, a covering film such as plating, a coated film composed of a composition other than the resin composition in the present invention, plasma and laser.

Examples of a preferable adherend include electric and electronic parts such as an integrated circuit and a printed circuit board which are a composite material of a synthetic polymer material and a metal.

### EXAMPLES

The following Examples further illustrate the present invention in more detail, but the present invention is not limited.

As the component (A) and the component (B), following were used.

MFR (melt flow rate) was according to JIS-K7210, and a value measured under conditions of 190° C. and a load of 2160 g is shown.

<Component (A)>

A-1: “adipic acid” manufactured by Nakalai Tesque (Inc.), extra pure reagent

A-2: “sebacic acid” manufactured by Nakalai Tesque (Inc.), extra pure reagent

A-3: “1,10-decanedicarboxyric acid” manufactured by Nakalai Tesque (Inc.) extra pure reagent

A-4: “benzoic acid” manufactured by Wako Pure Chemical Industries, Ltd., guaranteed reagent

<Component (B)>

B-1: ethylene-glycidyl methacrylate copolymer (MFR=350 g/10 min) manufactured by Sumitomo Chemical Co., Ltd., content of glycidyl methacrylate 18.0% by weight

B-2: ethylene-glycidyl methacrylate copolymer (MFR=3 g/10 min) manufactured by Sumitomo Chemical Co., Ltd., content of glycidyl methacrylate 12.0% by weight

B-3: ethylene-methyl acrylate-glycidyl methacrylate copolymer (MFR=9 g/10 min) manufactured by Sumitomo Chemical Co., Ltd., content of glycidyl methacrylate 6.0% by weight, content of methyl acrylate 30.0% by weight

<Component (C)>

Phenolic antioxidant C-1:

Irganox 1076 manufactured by Ciba Specialty Chemicals [(3,5-di-t-butyl-4-hydroxyphenyl)propionic acid strearyl ester]

Phosphoric antioxidant C-2:

Irgafos 168 manufactured by Ciba Specialty Chemicals [tris(2,4-di-t-butylphenyl)phosphite]

Sulfuric antioxidant C-3:

Sumilizer TP-D manufactured by Sumitom of Chemical Co., Ltd. [pentaerythryltetrakis-3-laurylthiopropionate]

### Examples 1 to 6, and Comparative Examples 1 to 2

[Molding of Thermosetting Resin Composition, Irradiation of Molded Body with Electron Beam and Preparation Example of Adhesive Film]

A total amount 80 g of a component (A), a component (B) and a component (C) having a ratio described in Table 1 or Table 2 were placed into Laboplast Mill (kneader) manufactured by Toyo Seiki Seisaku-sho, Ltd. having a volume of 100 cc, and the components were pre-kneaded for 7 minutes under condition of a barrel set temperature of 140° C. while a rotor were rotated at a rate of 10 rotations per minute. Subsequently, the mixture was kneaded for 5 minutes under condition of a barrel set temperature of 140° C. while a rotor was rotated at a rate of 60 rotations per minute, to obtain a thermosetting resin composition. The resulting thermosetting resin composition was used to form a thermosetting resin layer having a thickness of 100 μm on one releasing-treated surface of a polyethylene terephthalate film (manufactured by Teijin DuPont Film×31, thickness 38 μm) at a hot platen set temperature of 120° C. using a heat press, to obtain a laminated film having a two-layered structure.

Then, the surface of the thermosetting resin composition was irradiated with 140 kGy of an electron beam (acceleration voltage 225 kV) using an electron beam irradiation apparatus (acceleration voltage 100 to 250 kV, irradiation beam width 150 mm) manufactured by Iwasaki Electric Co., Ltd., to obtain an adhesive film having a thickness of a thermoplastic resin composition layer of 100 μm. The resulting adhesive film was subjected to measurement of dynamic viscoelasticity and preparation of a laminate.

[Measurement of Dynamic Viscoelasticity of Adhesive Film Obtained by Irradiation with Electron Beam]

A releasing PET film was peeled from the adhesive film having a two-layered obtained by irradiation with an electron bean and, after 150° C.×2 hour heating, a storage elastic modulus of the adhesive film was measured under conditions of a frequency of 10 Hz, and a strain of 0.1% at a temperature rising rate of 20° C./min from measurement initiation to 150° C., using a dynamic viscoelasticity measuring apparatus (“dynamic viscoelasticity measuring apparatus DVA=220” manufactured by IT Keisokuseigyo (K.K.)) in a shear mode.

As a result, as described in Table 1, the adhesive films of Comparative Examples 1 and 2 using a monocarboxylic acid compound A-4 had low storage elastic modulus after thermal curing (150° C.×2 hours).

Therefore, a test for assessing a laminate was not performed regarding the adhesive films of Comparative Examples 1 and 2.

[Preparation Example 1 of Laminate using Adhesive Film Obtained by Irradiation with Electron Beam, and Peeling Test]

Regarding the adhesive film having a two-layered structure obtained by irradiation with an electron beam (thickness of thermosetting resin composition layer is 100 μm), the thermosetting resin composition layer and a copper plate (JIS H 3100, tough pitch copper, thickness 0.5 mm) were laminated, and thermally contact-bonded under conditions of a temperature of upper and lower rolls of 150° C., a linear pressure of 14.5 kg/cm and a rate of 0.5 m/min using a laminator (“First Laminator VA-700” manufactured by Taisei Laminator CO. JP).

Then, a releasing PET film on the surface of a laminate was peeled, a polyimide film (UPILEX S having a thickness of 50 μm manufactured by Ube Industries, Ltd.) was laminated on an adhesive film side, and the polyimide film was thermally contact-bonded at 200° C. for 10 seconds at a pressure of 0.5 MPa from up and down, at a sealing width of 25 mm using a heat seal tester (manufactured by Tester Sangyo Co., Ltd.), to obtain a laminate. The resulting laminate was thermally cured for 2 hours in an oven at 150° C., to obtain a laminate for a peeling test.

A test piece for a peeling test having a width of 10 mm was excised from the resulting laminate, 90 degree peeling was performed at a peeling rate of 50 mm/min, and the results are shown in Table 3 and Table 4.

[Preparation Example 2 of Laminate using Adhesive Film Obtained by Irradiation with Electron Beam, and Moisture Absorption Solder Heat Resistance Test]

Regarding the adhesive film having a two-layered structure obtained by irradiation with an electron beam (thickness of thermosetting resin composition layer is 100 μm), the thermosetting resin composition layer and a surface blackening-treated copper plate (C15150-H, thickness 0.76 mm) were laminated, and thermally contact-bonded under conditions of a temperature of upper and lower rolls of 150° C., a linear pressure of 14.5 kg/cm and a rate of 0.5 m/min using a laminator (“First Laminator VA-700” manufactured by Taisei Laminator (K.K.)). Subsequently, a releasing PET film on the surface of a laminate was peeled, a polyimide film (UPILEX S having a thickness of 50 μm manufactured by Ube Industries, Ltd.) was laminated on an adhesive film side, and thermally contact-bonded two times under conditions of a temperature of upper and lower rolls of 140° C., a linear pressure of 14.5 kg/cm and a rate of 0.5 m/min using a laminator (“First Laminator VA-700” manufactured by Taisei Laminator (K.K.)), to obtain a laminate.

A test piece of 40 mm width×40 mm length was excised from the resulting laminate, and subjected to moisture absorption for 24 hours under environment of 30° C. and relative humidity of 90%, the test piece was placed on a hot plate at 260° C., and a moisture absorption solder heat resistance test was performed.

The test results are summarized in Table 3 and Table 4. Assessment criteria in the moisture absorption solder heat resistance test are as follows:
◯: Abnormality of blister and peeling is not recognized in a laminate.
x: Abnormality such as blister and peeling is recognized in a laminate.

Part in Table1 to Table 4 indicates part by weight, and * symbol in Table 1 and Table 2 indicates storage elastic modulus (Pa) after thermal curing.

TABLE 1

| Mixing | | | | | | | Comparative | Comparative |
|---|---|---|---|---|---|---|---|---|
| ratio | Example 1 | Example 2 | Example 3 | Example 4 | Example 5 | Example 6 | Example 1 | Example 2 |
| A-1 | — | — | 2 parts | 5 parts | 2 parts | 1 part | — | — |
| A-2 | 1 part | — | — | — | — | — | — | — |
| A-3 | — | 1 part | — | — | — | — | — | — |
| A-4 | — | — | — | — | — | — | 1 part | 5 parts |
| B-1 | 75 parts | 75 parts | 75 parts | 75 parts | 75 parts | 75 parts | 75 parts | 75 parts |
| B-2 | 25 parts | 25 parts | — | — | 25 parts | 25 parts | 25 parts | 25 parts |
| B-3 | — | — | 25 parts | 25 parts | — | — | — | — |
| C-1 | 0.1 part | 0.1 part | 0.1 part | 0.1 part | 0.1 part | 0.1 part | 0.1 part | 0.1 part |
| C-2 | 0.1 part | 0.1 part | 0.1 part | 0.1 part | 0.1 part | 0.1 part | 0.1 part | 0.1 part |
| C-3 | 0.05 part | 0.05 part | 0.05 part | 0.05 part | 0.05 part | 0.05 part | 0.05 part | 0.05 part |
| Elastic | 3.2E5 | 3.3E5 | 5.1E5 | 1.4E6 | 6.5E5 | 3.5E5 | 8.6E4 | 1.1E5 |
| modulus | | | | | | | | |
| Pa* | | | | | | | | |

TABLE 2

| Mixing | | | | |
|---|---|---|---|---|
| ratio | Example 7 | Example 8 | Example 9 | Example 10 |
| A-1 | — | — | — | — |
| A-2 | 1 part | — | 1 part | — |
| A-3 | — | 1 part | — | 1 part |
| A-4 | — | — | — | — |
| B-1 | 85 parts | 85 parts | 75 parts | 75 parts |
| B-2 | — | — | — | — |
| B-3 | 15 parts | 15 parts | 25 parts | 25 parts |
| C-1 | 0.1 part | 0.1 part | 0.1 part | 0.1 part |
| C-2 | 0.1 part | 0.1 part | 0.1 part | 0.1 part |
| C-3 | 0.05 part | 0.05 part | 0.05 part | 0.05 part |
| Elastic | 3.3E5 | 3.9E5 | 3.9E5 | 2.5E5 |
| modulus | | | | |
| Pa* | | | | |

TABLE 3

| Mixing | | | | | | |
|---|---|---|---|---|---|---|
| ratio | Example 1 | Example 2 | Example 3 | Example 4 | Example 5 | Example 6 |
| A-1 | — | — | 2 parts | 5 parts | 2 parts | 1 part |
| A-2 | 1 part | — | — | — | — | — |
| A-3 | — | 1 part | — | — | — | — |
| B-1 | 75 parts | 75 parts | 75 parts | 75 parts | 75 parts | 75 parts |
| B-2 | 25 parts | 25 parts | — | — | 25 parts | 25 parts |
| B-3 | — | — | 25 parts | 25 parts | — | — |
| C-1 | 0.1 part | 0.1 part | 0.1 part | 0.1 part | 0.1 part | 0.1 part |
| C-2 | 0.1 part | 0.1 part | 0.1 part | 0.1 part | 0.1 part | 0.1 part |
| C-3 | 0.05 part | 0.05 part | 0.05 part | 0.05 part | 0.05 part | 0.05 part |
| Peeling | 11.9 N/cm | 9.7 N/cm | 7.2 N/cm | 7.9 N/cm | 7.1 N/cm | 8.2 N/cm |
| test | | | | | | |
| Moisture | ◯ | ◯ | ◯ | ◯ | ◯ | ◯ |
| absorption | | | | | | |
| solder heat | | | | | | |
| resistance test | | | | | | |

TABLE 4

| Mixing | | | | |
|---|---|---|---|---|
| ratio | Example 7 | Example 8 | Example 9 | Example 10 |
| A-1 | — | — | — | — |
| A-2 | 1 part | — | 1 part | — |
| A-3 | — | 1 part | — | 1 part |
| B-1 | 85 parts | 85 parts | 75 parts | 75 parts |
| B-2 | — | — | — | — |
| B-3 | 15 parts | 15 parts | 25 parts | 25 parts |
| C-1 | 0.1 part | 0.1 part | 0.1 part | 0.1 part |
| C-2 | 0.1 part | 0.1 part | 0.1 part | 0.1 part |
| C-3 | 0.05 part | 0.05 part | 0.05 part | 0.05 part |
| Peeling | 17.1 N/cm | 16.3 N/cm | 26 N/cm | 26 N/cm |
| test | | | | |
| Moisture | ◯ | ◯ | ◯ | ◯ |
| absorption | | | | |
| solder heat | | | | |
| resistance | | | | |
| test | | | | |

The adhesive film of the present invention is excellent in processibility, thermosetting property, adherability and solder heat resistance. In addition, the adhesive film of the present invention is also excellent in adherability in a thin film. Further, in the adhesive film of the present invention, flowing out of a resin is suppressed upon thermal curing. And, when the adhesive film of the present invention is laminated with an adherend and thermally cured, a laminate having an adhesive layer of a low elastic modulus is obtained.

1. An adhesive film obtained by a method comprising a step of molding a thermosetting resin composition comprising component (A) and component (B) into a film, and a step of irradiating the film with an electron beam:
(A): a polyvalent carboxylic acid containing two or more carboxyl groups, or anhydride thereof;
(B): an ethylene copolymer containing epoxy group obtained by addition polymerization of at least one of monomer (b1) and monomer (b2):
monomer(b1): at least one of ethylene and propylene;
monomer(b2): a monomer represented by the following formula (1): 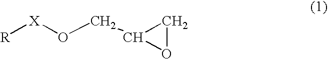
(wherein R represents a hydrocarbon group of from 2 to 18 carbon number having one or more double bond(s), wherein a hydrogen atom of the hydrocarbon group may be substituted with a halogen atom, a hydroxyl group or a carboxyl group, and X represents a single bond or a carbonyl group).

2. The adhesive film according to claim 1, wherein the polyvalent carboxylic acid is aliphatic polyvalent carboxylic acid.

3. The adhesive film according to claim 1, wherein the polyvalent carboxylic anhydride is aliphatic polyvalent carboxylic anhydride.

4. The adhesive film according to any one of claims 1 to 3, wherein a content of a repeating unit derived from the (b2) is from 1 to 30 parts by weight relative to 100 parts by weight of the component (B).

5. The adhesive film according to any one of claim 1, wherein the component (B) is a copolymer obtained by addition polymerization of the (b1), the (b2) and the following monomer (b3):
(b3) monomer: a monomer has a functional group copolymerizable with ethylene without a functional group capable of reacting with an epoxy group, and is different from the (b1) and the (b2).

6. The adhesive film according to any one of claims 1 or 5, wherein a content of an ethylene unit derived from the (b1) is 30 to 75 parts by weight relative to 100 parts by weight of the component (B).

7. The adhesive film according to any one of claims 1, wherein a weight ratio of the component (A) and the component (B) is 0.01/99.99 to 5/95.

8. The adhesive film according to any one of claims 1, wherein the thermosetting resin component further contains the following component (C):
component (C): Antioxidant.

9. The adhesive film according to claim 8, wherein the component (C) is at least one antioxidant selected from the group consisting of a phenolic antioxidant, a phosphoric antioxidant and a sulfuric antioxidant.

10. An adhesive film obtained by a method comprising a step of coating on a supporting substrate a thermosetting resin composition which comprises the component (A), the component (B) and the following component (D), a step of removing the component (D), and a step of irradiating the resulting composition on a supporting substrate with an electron beam; component (D): at least one of organic solvent and water.

11. The adhesive film according to claim 10, wherein the thermosetting resin composition further comprises the component (C).

12. The adhesive film according to claim 10 or 11, wherein a total weight of the component (A) and the component (B) is 10 to 150 parts by weight relative to 100 parts by weight of the component (D).

13. The adhesive film according to claim 1 or 8, wherein the film is molded by extruding.

14. A cured laminate obtained by the method comprising a step of laminating the adhesive film according to any one of claim 1, 8, 10 or 11, and an adherend, and a step of thermally curing the laminate.

15. A devise for a semiconductor apparatus obtained by by the method comprising a step of laminating the adhesive film according to any one of claim 1, 8, 10 or 11, and an adherend, and a step of thermally curing the laminate.

16. A semiconductor apparatus, which comprises the device according to claim 15.
